(19) United States
(12) Patent Application Publication
(10) Pub. No.: US 2022/0007885 A1
(43) Pub. Date: Jan. 13, 2022

(54) METHOD AND SYSTEM FOR CAVITY STATE DETERMINATION

(71) Applicant: June Life, Inc., San Francisco, CA (US)

(72) Inventors: Nikhil Bhogal, San Francisco, CA (US); Robert Cottrell, San Francisco, CA (US); Jithendra Paruchuri, San Francisco, CA (US)

(21) Appl. No.: 17/365,880

(22) Filed: Jul. 1, 2021

Related U.S. Application Data
(60) Provisional application No. 63/049,488, filed on Jul. 8, 2020.

(51) Int. Cl. A47J 36/32; G05B 13/02; A23L 5/10; A47J 37/06; F24C 7/08

(52) U.S. Cl. CPC A47J 36/321; G05B 13/027; A23V 2002/00; A47J 37/0629; F24C 7/081; A23L 5/15

(57) ABSTRACT

A method for cavity state determination including: receiving a cook instruction; sampling a set of cavity measurements; determining a cavity state; and selectively operating the cook cavity based on the match.

### CROSS-REFERENCE TO RELATED APPLICATIONS

This application claims the benefit of U.S. Provisional Application No. 63/049,488 filed 8 Jul. 2020, which is incorporated in its entirety by this reference. This application is related to U.S. application Ser. No. 15/147,597 filed 5 May 2016 and U.S. application Ser. No. 17/201,953 filed 15 Mar. 2021, each of which is incorporated in its entirety by this reference.

### TECHNICAL FIELD

This invention relates generally to the appliance field, and more specifically to a new and useful method for appliance state monitoring in the appliance field.

### BRIEF DESCRIPTION OF THE FIGURES

FIG. 1 is a schematic representation of the method.

FIG. 2 is a schematic representation of the system.

FIG. 3 is a schematic representation of an embodiment of the method.

FIG. 4 is a schematic representation of an embodiment of the method.

FIG. 5 is a schematic representation of a second embodiment of the method.

FIGS. 6A and 6B are illustrative representations of examples of the appliance.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

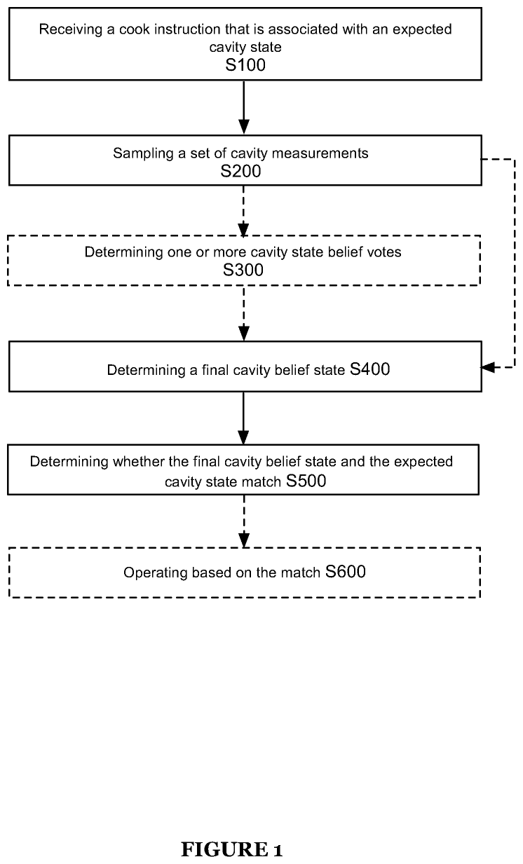

As shown in FIG. 1, the method for cavity state determination can include: receiving a cook instruction that is associated with an expected cavity state S100; sampling a set of cavity measurements S200; optionally determining one or more cavity state belief votes S300; determining a final cavity belief state S400; determining whether the final cavity belief state and the expected cavity state match S500; optionally operating based on the match S600; and/or any other suitable elements.

Additionally or alternatively, the method for automated appliance operation can include: receiving a cook instruction (e.g., S100); sampling a set of cavity measurements (e.g., S200); determining a cavity occupancy state based on the cavity measurements (e.g., S300); and selectively operating the appliance based on the cavity occupancy state (e.g., S400). The method can optionally infer a user intent based on a comparison of historical cavity states, and selectively operate the appliance based on the inferred user intent. Inferring a user's intent can be used to alert a user if the detected state does not match the expected state from a cook program. For example, if a user is using an airfry pan and the oven is set to bake, the oven can alert (re-confirm) the user's intent based on the cavity state inferred from an accessory model.

### 2. Examples

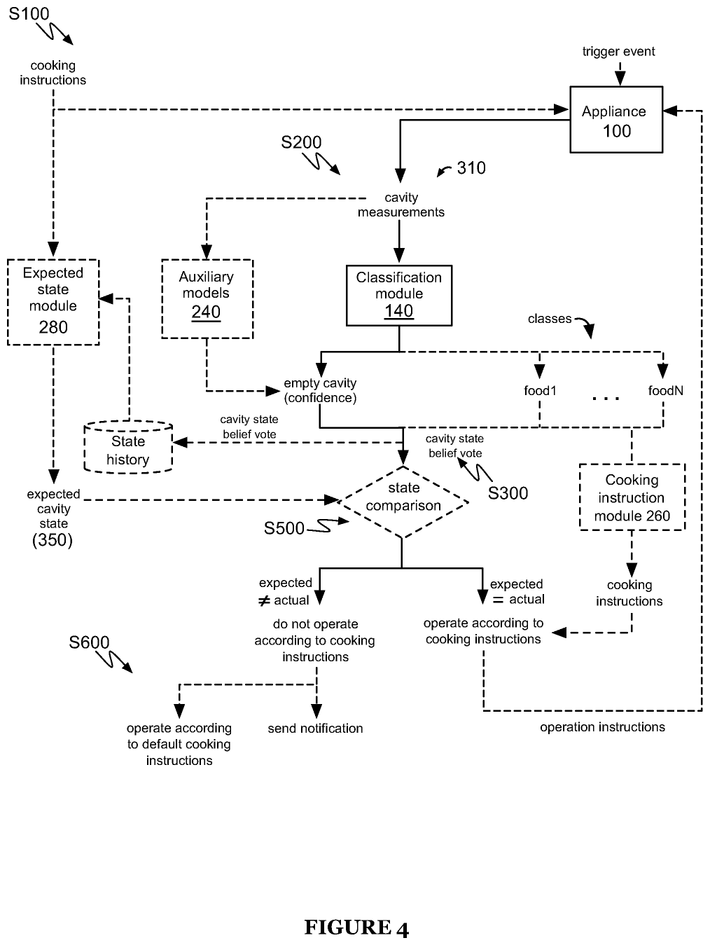

In a first specific example (illustrative example shown in FIG. 4), the method can include: at an appliance, receiving a pre-heat instruction associated with an expected empty cavity state (e.g., cavity should not include foodstuff, but can include accessories, or not include accessories); capturing a series of images of the appliance's cavity using an appliance camera; determining a class label for the appliance cavity (e.g., the class with the highest probability amongst all classes), wherein the class label can be associated with one of empty or full (e.g., does not or does contain foodstuff, respectively); comparing the class label to the expected cavity state (e.g., empty cavity state); pre-heating the appliance only if the class label matches the expected cavity state (e.g., indicates that the cavity is empty); and operating the appliance according to default instructions when the class label and expected cavity state are mismatched. Examples of default operation include: notifying the user to perform an action, such as removing foodstuff from the cavity; and identifying the cavity contents, determining cooking instructions based on the cavity content identifier, and operating the appliance according to the cooking instructions.

In a second specific example, the method can include: while rapidly preheating the cavity (e.g., preheating at a high power output), detecting a foodstuff insertion event (e.g., door opening and closing; detecting cavity occupancy; etc.), and automatically shutting off preheat (e.g., reducing power output to a lower output, turning the heating element off, reverting to a lower intensity heat output, etc.) when the cavity state is not empty (e.g., determined based on the cavity measurements, etc.) and/or after the insertion event is detected. The method can optionally include verifying that the cavity state is empty before resuming preheating.

In a third specific example, the method can include: at an appliance, receiving the pre-heat instruction; capturing a set of sensor measurements, wherein the set of sensor measurements includes subsets of measurements from respective sensors of the appliance; determining a cavity state belief vote for each subset of measurements; and combining the cavity state belief votes to determine a final cavity belief vote.

In a fourth specific example, the method can automatically shut off the heating elements after the cavity is determined to be empty for a predetermined time period.

### 3. Benefits

The method confers several benefits over conventional systems.

First, automated appliances, such as connected ovens, can be designed to reduce manual control and cognitive overhead by automatically controlling appliance operation. However, removing this cognitive overhead can lead to a poor user experience, since the user is no longer paying attention to whether the current cook cavity state is suitable for the next desired cooking step. For example, the appliance's cook cavity can be rapidly preheated by operating the heating elements at their maximum power output, which can be higher than the cooking power output (e.g., higher than the cooking temperature). Unfortunately, users oftentimes forget to turn off the preheat setting after placing food into the cavity, which results in burnt food. By automatically detecting cavity state (e.g., empty/not empty), the method can automatically halt preheating and optionally operate the heating elements at the food-appropriate power output when food is detected. In another example, the method can verify that the cavity is empty before pre-heating the oven to prevent the foodstuff from burning.

Second, automatic cavity state detection also enables use of rapid preheating (since the user no longer needs to monitor the temperature or power output setting), thereby enabling faster preheating and a better user experience.

Third, in order to satisfy hardware constraints of the appliance, the inventors discovered that, in some variants, a food identification classifier can also be used to determine empty and full cavity labels. In the first example, a single classifier can output probabilities for food classes and an empty class. In this example, the cavity is considered empty when the empty class has the highest probability amongst the output classes (or satisfies another condition), and is otherwise considered as occupied. In a second example, an empty cavity can be determined by taking the union of two or more classes that both indicate an empty cavity (e.g., empty-cavity-clean-camera and empty-cavity-dirty-camera), rather than using an additional model trained specifically for empty cavity and/or full cavity classification.

Fourth, although the camera to processor communication can be slow, the method and system enable near-real-time classification by capturing multiple images and processing the images until the classifier achieves a predetermined confidence level, which enables the method and system to determine a class label within a few seconds.

However, the method and system can confer any other suitable benefits.

### 4. System

The method is preferably performed using a system including: an appliance 100, one or more sensors 120, one or more classification modules 140, one or more computing systems 16o (e.g., local, remote, etc.), one or more communication systems 18o (e.g., APIs, Wifi system, cellular system, Bluetooth system, etc.), one or more datastores 200, one or more user devices 220, and/or any other suitable components. However, the method can be performed with any other suitable system.

The appliance 100 can function to perform one or more elements of the method.

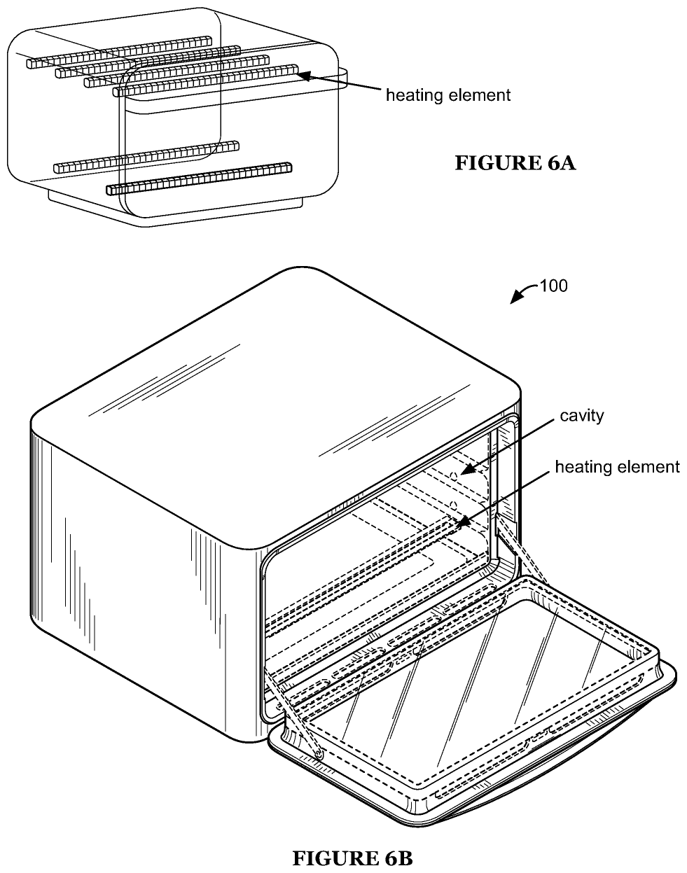

The appliance can include one or more heating elements (e.g., 3, 4, 5, 6, 7, 8, etc.) evenly or unevenly distributed along the cavity top, bottom, and/or other surface. The heating elements can be operable between rapid on/off modes with minimal hysteresis after a heating element state change, or have any other suitable heating and shutoff profiles. The heating elements can be operable in a high-power mode (e.g., operating the heating elements at 100% power output or more than a threshold or minimum power output, such as 90%, 75%, 60%, etc.), low-power mode (e.g., operating the heating elements at less than a threshold power output, such as 90%, 80%, 70%, 50%, etc.), an off mode (e.g., power turned off), and/or any other suitable mode. The heating elements can have adjustable power output (e.g., variable control, continuously variable control, three or more operation modes, etc.), binary power output, and/or any other suitable power output. The heating elements can be metal, ceramic, carbon fiber, composite (e.g., tubular sheathed heating element, screen-printed metal-ceramic tracks, etc.), resistive, gas, carbonaceous (e.g., charcoal), or be any other suitable heating element. In a specific example, the appliance can include multiple carbon fiber heating elements (example shown in FIG. 6A). The power output of each heating element can be: between 300 W-600 W (e.g., 450 W), and/or any other suitable power output. The total power output of the heating elements can be 1800 watts, 1700 watts, 1600 watts, 1500 watts, between 1000 watts and 2000 watts or any range defined therein, and/or have any other suitable power output. The maximum temperature of the multiple carbon fiber heating elements can be above, below, or equal to: 300° F. 500° F., 700° F., and/or any other suitable temperature.

The appliance can define a cavity that receives food, accessories (e.g., plate, pan, baking sheet, pot, etc.), racks, and/or other items. The cavity can include the heating elements, and additionally cooling elements, convection elements, and/or other cooking elements. The cavity can be accessible through a door (e.g., side door, top door, etc.) or otherwise accessed. The cavity can be associated with cavity measurements that monitor parameters of the cavity. The cavity measurements are preferably used by the method for cavity state determination, for determining a maintenance issue, and/or for any other suitable process. The cavity measurements can include images, videos, audio, vibration, weight changes, light changes, temperature, and/or any other suitable measurement.

The appliance can include memory (e.g., non-volatile, volatile, etc.) for which to store one or more cavity states. The appliance can include a processor for sampling and recording cavity measurements, a communication system for receiving and/or transmitting information (e.g., to and/or from the remote computing system and/or a user device), and/or any other suitable elements. Examples of appliances include: ovens (e.g., example shown in FIG. 6B), toasters, slow cookers, air fryers, warming drawers, broilers, cooktops, grills, smokers, dehydrators, and/or any other suitable appliance. A specific example of an appliance is described in U.S. application Ser. No. 16/793,309 filed 18 Feb. 2020, which is incorporated herein in its entirety by this reference.

The system can include one or more sensors 120 for determining the cavity measurements. The sensors are preferably integrated into the appliance, but can additionally or alternatively be separate. The sensors can include one or more optical sensors (e.g., image sensors, light sensors, cameras, etc.), audio sensors, temperature sensors, door sensors (e.g., a switch coupled to the door to detect door open and/or close state, etc.), power sensors (e.g., Hall effect sensors), inertial sensors (e.g., accelerators, gyroscope, magnetometer, etc.), 3D scanners, door sensor, infrared sensor, ultrasound sensors, temperature sensors (e.g., temperature probe, cavity thermometer, etc.), weight sensors (e.g., load cells in the rack supports, oven feet, etc.), and/or any other suitable sensors. The sensors can be directly or indirectly coupled to and/or monitor the cavity. The sensors can be connected to and controlled by the processor of the appliance, a user device, or be otherwise controlled. The sensors are preferably individually indexed and individually controlled, but can alternatively be controlled together with other like sensors.

In one variation, the sensors can include an optical sensor that functions to measure optical data about the cavity (e.g., foodstuff within the cook cavity). In a first embodiment, the sensor includes a camera (e.g., CCD, stereo, wide angle etc.) configured to record images or video of the cavity (e.g., food cooking within the cavity). However, the one or more sensors can additionally or alternatively include any other suitable components.

The system (e.g., each appliance, a system including a set of appliances, etc.) can include a computing system 160, which can function to perform all or part of the method and/or any other suitable process. The computing system can be integrated with a processing system and/or be separate. The computing system can include: a remote computing system, a local computing system (e.g., local to an appliance, local to a user device 220, etc.), and/or other hardware components. The computing system can include and/or execute: a classification module 140, and can optionally include: a cook instruction module 260, an expected state module 280, a notification module, an appliance functionality control module, and/or any other suitable software modules.

The computing system can include a classification module 140, which can function to determine a cavity state (e.g., occupancy state, such as empty or occupied). The classification module can optionally function to determine one or more food classes for food within the cavity. The classification module can include an image classifier, an event classifier, and/or any other suitable classifier. The classifiers can be one or more machine learning classifiers such as neural networks (e.g., DNN, CNN, transformers, etc.), decision trees (e.g., random forests), linear classifiers (e.g., logistic regression, Naive Bayes, etc.), support vector machines (e.g., least squares), quadratic classifiers, clustering classifiers (e.g., k-nearest neighbors), and/or any other suitable classifier. The classifiers can be binary classifiers, multi-class classifiers, and/or any other suitable classifier.

In a first example, the classification module includes a single classifier configured to classify the image as one of a predetermined set of food classes or an empty cavity state class. In this example, the class with the highest probability (e.g., absolute highest; highest by more than a threshold value; etc.) can be considered the final classification (e.g., final cavity belief state). In a second example, the classification module includes at least two classifiers, wherein one classifies the cavity image as empty or occupied, and another determines the food class for food depicted within the cavity image. In a third example, the classification module includes multiple classifiers (e.g., binary classifiers), wherein each classification module determines whether the image is associated with the module's respective class. However, the classification module can be otherwise configured.

The classification module and/or computing system can include auxiliary models 240, which can function to estimate cavity state based on one or more cavity measurements. The cavity measurements can be the same or different measurements as that used by the cavity state module. The auxiliary models can include: classifiers, regression models, filters, and/or other models. The auxiliary models can include and/or use: filters (e.g., high pass, low pass, band pass, etc.), thresholds (e.g., readings can be above or below a predetermined threshold, a difference between two readings can be above or below a predetermined threshold, etc.), heuristics (e.g., connectivity, sensor state, etc.). Examples of the auxiliary models include: models for temperature (e.g., to detect a temperature decrease or increase by a predetermined amount), models for weight (e.g., to detect weight increases or decrease by predetermined amounts), models for door sensors (e.g., rules and/or heuristics based on door open and/or door close detections), and/or any other suitable models. However, the classification module can additionally or alternatively include any other suitable elements.

The computing system can include a cooking instruction module 260, which can function to determine cooking instructions. The cooking instructions can be determined: based on the determined food class, by a user, based on the cavity state belief vote or a final cavity belief state, by a recipe or menu, and/or otherwise determined. The cooking instruction module can use a look-up table to determine the cooking instruction, query a database, and/or otherwise determine the cooking instruction. However, the cooking instruction module can be otherwise configured.

The computing system can include an expected state module 280, which can function: to record a history (e.g., remember) prior cavity belief states; determine an associated expected cavity state 350 for a particular cooking instruction; and/or perform any other suitable functionality. The expected state module can determine the associated expected cavity state by applying one or more rulesets, filters, and/or heuristics to the cooking instructions, and/or otherwise determine the expected cavity state. In a first example, when the cooking instruction is pre-heat, the ruleset can indicate that the expected cavity state is empty. In a second example, when the cooking instruction is cook a foodstuff at a predetermined temperature, the ruleset can indicate that the expected cavity state is non-empty (e.g., food present, specific food type, etc.). However, the expected state module can be otherwise configured.

The computing system can include a notification module, which can function to determine and/or send notifications to the appliance and/or user device based on whether the final cavity belief state (or cavity belief votes) and the expected cavity state match. The notification can be determined using rulesets, heuristics, querying a database using the match result, and/or otherwise determining the notification. However, the notification module can be otherwise determined.

The computing system can include an appliance functionality control module, which can function to determine a state change event (functionality change) for the appliance based on whether the final cavity belief state (or cavity belief votes) and the expected cavity state match, based on one or more sensor measurements (e.g., door open and/or close event, etc.), and/or otherwise based. The state change event can be determined by querying a datastore, by using rulesets, heuristics, and/or otherwise determining the state change event. When the state change event is detected, one or more elements of the method can be performed. In a first example, when the state change event is detected, the appliance functionality control module can: determine a cavity state of the cook cavity using a sensor measurement of the cook cavity, captured by the sensor set; operate the appliance according to the pre-heat instruction (e.g., maximum power output, high power output, predetermined power output, etc.) when the cavity state matches the empty cavity state; operate the appliance according to the operation instructions (e.g., secondary operation instructions) when the cavity state does not match the empty cavity state (e.g., operate the appliance in a low-power mode when the cavity state is not empty); and/or any other suitable elements.

However, the appliance functionality control module can be otherwise configured.

However, the computing system can additionally or alternatively include any other suitable components.

The system can include one or more datastores 200, which can function to store: a history of previous cavity states (e.g., cavity state belief votes, final cavity belief states, etc.); look up tables (e.g., to determine cook instructions, cavity states associated with cook instructions, etc.), and/or any other suitable information. However, the datastore can be otherwise configured.

The system can include one or more user devices 220, which can function to send a trigger event to an appliance (e.g., instruction, such as a pre-heat instruction, turn off instruction, temperature change instruction, etc.). The trigger event can be sent by the user device when the user device is: remote from the appliance, local to the appliance, and/or otherwise located relative to the appliance. The user device can be a smartphone, tablet, laptop, computer, smart appliance (e.g., connected sous vide, toaster, other oven, refrigerator, stove, pan, etc.), and/or any other suitable device. However, the user device can be otherwise configured.

The system can be used with recipes, cook programs, cook primitives, operation instructions, cook instructions, and/or any other suitable instruction elements. The instruction elements can be specific to an appliance type or class, or globally applicable.

The recipes can include: ingredients, user instructions, cook programs, and/or any other suitable elements. The cook programs can include a series of operation instructions, cook primitives, and/or any other suitable elements. The cook primitives can include appliance operation settings. The cook primitives can be associated with a predefined, static and/or dynamic set of operation instructions, automatically adjusted operation instructions (e.g., adjusted based on visual and/or temperature cues as the food cooks), or other operation instructions. The cook primitives can be manually selected, automatically selected, and/or otherwise selected. Examples of the cook primitives include preheat, bake, broil, roast, fry, dehydrate, and/or any other suitable cook primitive. The operation instructions can include: operation targets (e.g., target power output, power input, power cycling, etc.), operation duration, timeseries, and/or any other suitable instruction. The operation instructions can be machine instructions, user input instructions, and/or any other suitable instructions. However, instruction elements can be otherwise defined.

The cook instruction can be the recipes, cook programs, cook primitives, and/or any other suitable instruction. Each cook instruction can be associated with an expected cavity state (e.g., required or suggested cavity state before a next action is executed). The association can be retrieved from an expected state datastore, determined by an expected state module, hardcoded (e.g., into the operation instructions), or otherwise determined. An example is depicted in FIG. 4.

However, the system can additionally or alternatively be used with any other suitable elements.

### 5. Method

The method for cavity state determination preferably includes receiving a cook instruction that is associated with an expected cavity state S100, sampling a set of cavity measurements S200, determining one or more cavity state belief votes S300, optionally determining a final cavity belief state S400, determining whether the final cavity belief state and the expected cavity state match S500, and optionally operating based on the match S600, but the method can additionally or alternatively include any other suitable elements. The method is preferably automatically performed (e.g., by the computing system, by each appliance, etc.), but can be partially or entirely manually performed. The method is preferably performed each time a trigger event is detected (e.g., door open detection, door close detection, weight change detection, state change event detection, etc.), but can be performed periodically (e.g., during a cooking session) and/or at any other suitable time. The trigger event can be determined by the appliance itself, by a remote system (e.g., user device, remote computing system, etc.), and/or by any other suitable system.

The method can be performed at the edge (e.g., onboard the appliance, using limited computational power), at a remote computing system, using the system discussed above, and/or using any other system.

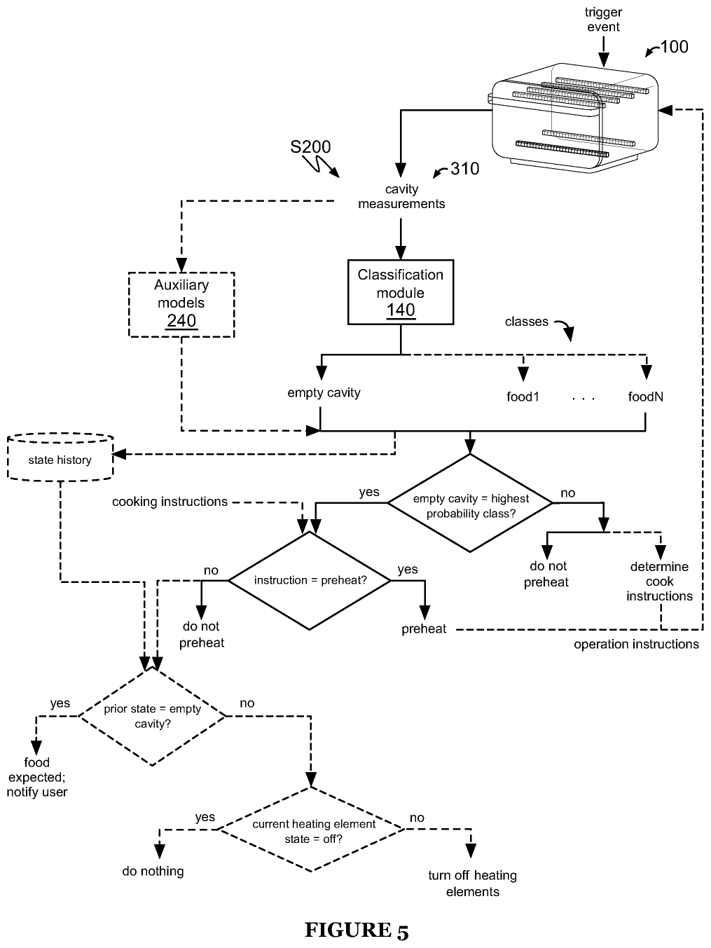

The method can include storing a time series of one or more previous belief states (e.g., most recent, associated with a predetermined event, etc.). Each previous belief state can be associated with a respective timestamp. One or more of the previous belief states can be used in addition to the cavity measurements to determine a final cavity belief state 370. For example, a final belief state can be “empty cavity” when a cavity measurement is classified as a door open and close event and the most recent previous belief state can be “full cavity”. The prior belief states can also be used to infer user intent. For example, when the current belief state (e.g., current cavity state) is empty, the cooking instructions are to not preheat (e.g., not heat or not cook), and the prior state was empty, the system can infer that the user meant to put food in the cavity and send a notification to the user to place food in the cavity (example shown in FIG. 5). However, if the prior state was not empty (e.g., food was in the cavity), the system can infer that the user forgot to turn off the oven, and automatically turn off the heating elements. However, the prior belief states can be otherwise used.

The method can be performed periodically (e.g., every 30 seconds, every minute, every 5 minutes, etc.), after a predetermined event (e.g., door open, door close, door open and door close), after receiving user input (e.g., cook instruction, button press, etc.), after receiving a user device instruction (e.g., based on the cook program associated with the scroll or dwell position within a recipe), and/or at any other suitable time.

The method preferably includes receiving a cook instruction S100, which can function to dictate how the oven should be controlled. The cook instruction can be associated with an expected cavity state, wherein S100 can function to determine an expected cavity state that an appliance cavity belief state can be compared to.

The expected cavity state can be indicative of a preferred appliance cavity state before performing the cook instruction at the appliance. For example, a cook instruction can include a preheat instruction, wherein the preheat instruction can be associated with an empty appliance cavity state. The expected cavity state is preferably binary (e.g., empty cavity or full cavity), but can additionally or alternatively be multi-class (e.g., empty cavity, full cavity, food type in cavity, clean cavity, dirty cavity, etc.).

The cook instruction can be received from the user operating the appliance (e.g., via a control panel of the appliance, such as a touchscreen), from a user device (e.g., the device local or remote with respect to the appliance, such as a remote pre-heat instruction), automatically determined, and/or otherwise received. The cook instruction can be received from a user input on the appliance; a remote device, such as a user input remote from the appliance (e.g., received over a wireless connection, such as WiFi or Bluetooth, etc.) or a remote computing system (e.g., remote server); an onboard processor, and/or from any other suitable source. The cook instructions can be received: individually (e.g., one cook instruction or primitive at a time), as part of a recipe (e.g., selected by the user, associated with a user- or automatically-detected food class, etc.), and/or received as any other suitable set of instructions. Examples of cook instructions include: power output targets, temperature targets, timers, preheat, bake, convection bake defrost, steam, grill, low-and-slow, and/or other cook instructions.

The expected cavity state can be determined as previously described, can be retrieved from querying a datastore, wherein the query includes the cook instruction and the result includes the expected cavity state, and/or the expected cavity state can be otherwise determined using the cook instruction. In a first example, the cook instruction is received from a user when a “preheat” button (e.g., primitive function) is selected. In a second example, the cook instruction is automatically determined based on the user device's browser position within a recipe (e.g., wherein the cook instruction can be within the next N steps after the current step). An example is depicted in FIG. 4. However, the cook instruction can be otherwise determined.

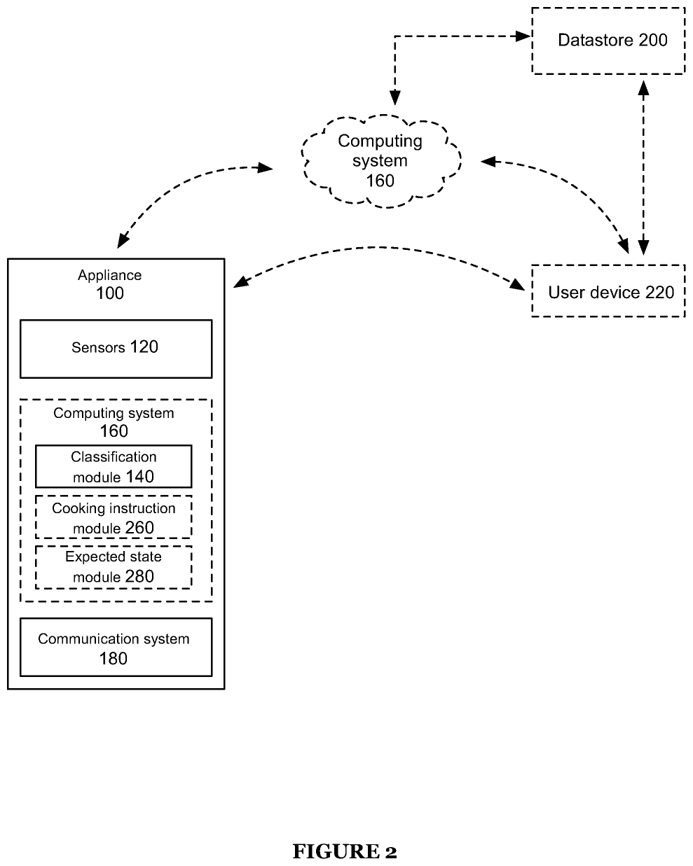

The method preferably includes sampling a set of cavity measurements S200, which can function to sample measurements from one or more sensors for subsequent cavity characterization. The cavity measurements 310 can be sampled from one or more of the sensors previously mentioned. The measurements can include images, videos, audio, vibration, weight changes, light changes, temperature, any other values (discrete or continuous), and/or any other suitable measurement. The sensors can be sampled after a predetermined event (e.g., cooking instruction determination, trigger event detection, door open, door close, etc.), periodically, and/or at any other suitable sampling rate. Each sensor can be sampled at the same rate, different rates, or at any other suitable rate. Each sensor can be sampled at a predetermined sampling rate (e.g., every 30 milliseconds, every 40 milliseconds, every 300 milliseconds, every 400 milliseconds, etc.), processing rate, maximum sampling rate, and/or other suitable rate, However, sampling the set of cavity measurements can additionally or alternatively include any other suitable elements. An example is depicted in FIG. 2.

The method can includes determining one or more cavity state belief votes S300, which can function to determine a cavity state belief (belief cavity state) for each sensor signal and/or for a combination of signals. The cavity state belief vote 330 can be an estimated state of the cavity based on a cavity measurement from a single sensor, from cavity measurements from multiple sensors, and/or based on any other suitable sensor measurement. Different cavity state belief votes can be from: different images, different sensors, different models, and/or otherwise varying sources. The cavity state belief votes can be combined (e.g., in S400) to determine a final cavity state belief using a majority voting scheme, supermajority voting scheme, and/or other voting scheme. However, the cavity state belief votes can be otherwise combined. The one or more cavity state belief votes can additionally be based on: a previous final cavity belief state; auxiliary information, such as from a user device (e.g., completion indication that a cook program is completed, etc.); and/or any other suitable information. For example, when the previous final cavity belief state is full and a door open and close event is not detected, then the cavity belief vote can be full (e.g., foodstuff present in the cavity).

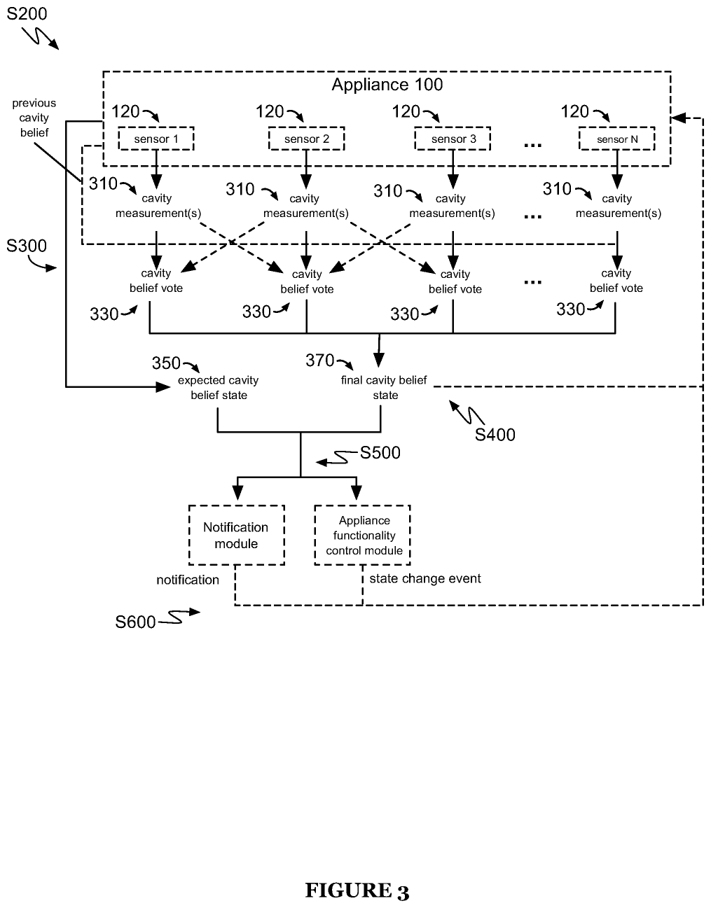

Determining one or more cavity state belief votes can include: processing each cavity measurement (or a subset thereof) from S200 to determine a respective cavity state belief vote; processing a combination of cavity measurements to determine a respective cavity state belief vote; and/or any other suitable elements. An example is depicted in FIG. 3.

Processing the cavity measurements can be performed using one or more classifiers and/or models of the classification module.

In a first variant, when the cavity measurements can include images captured by the camera, the images can be processed using an image classifier of the classification module to determine one or more cavity belief votes. The image classifier can include one or more output heads associated with class labels including one or more of: types of foodstuff, cavity state, camera state, accessory type, foodstuff quantity, or any other class label. Optionally each output head can determine and/or be associated with a respective confidence score for each class label.

In a first embodiment, the image classifier can be a trained neural network. The same neural network can output individual food classes in addition to the cavity state and/or camera state (e.g., empty cavity and clean camera; empty cavity and dirty camera; food type, such as bagel, chicken, bacon; accessory type; number of food items; volume of food items; etc.). In a specific example, the neural network outputs a probability for each of an empty cavity state and a set of food classes.

In a second embodiment, the image classifier can be a cascade of models (e.g., neural networks, decision trees, regressions, etc.). For example, a first classifier can classify the image as an empty cavity or not-empty cavity, and additional classifiers can classify the food class, accessory class, quantity class, camera state class, and/or any other suitable class.

In a third embodiment, the image classifier is a multi-class classifier, wherein the cavity state can be represented by a single class (e.g. “empty”) or multiple classes (e.g., “empty” and “not empty”). The multi-class classifier can optionally output confidence scores for classes. In this embodiment, the cavity state can be classified as “empty”: when the “empty” class has the highest confidence score out of all other classes, when the “empty” class has a confidence score above a predetermined threshold (e.g., 0.95), a combination thereof, and/or when another classification condition is met.

In a fourth embodiment the classifier is a 3-class classifier (e.g., first state second state; food), wherein the output class label can be post-processed to determine if the cavity state is empty (e.g., first state, second state, taking the union of class labels for the first state and the second state) or full (e.g., class label is food). In a specific example, the first state can be empty-clean-camera, and the second state can be empty-dirty-camera (e.g., determined using the method disclosed in U.S. application Ser. No. 17/201,953 filed 15 Mar. 2021, incorporated herein in its entirety by this reference).

In the previously described embodiments, when the class label is indicative of an empty cavity, then the cavity state belief vote for the sensor measurement is empty; when the class label is indicative of a full cavity, then the cavity state belief vote for the sensor measurement is full. However, the class labels can be otherwise interpreted and/or associated with cavity state belief values.

In the previously described embodiments, the image classifiers can be trained using images captured by clean cameras, dirty cameras (e.g., grease, smudges, food stains, etc.), slightly dirty cameras, images with accessories (e.g., pan, pots, etc.) but no food, images with food, images with food on accessories, and/or any other suitable images.

In a second variant, the cavity state belief vote is determined based on auxiliary sensor readings (e.g., used in addition to an image of the cook cavity, used as an alternative to an image of the cook cavity, etc.). Auxiliary sensor readings can include: appliance weight change (e.g., cavity is occupied when the weight increases, and is empty when the weight falls to or below a predetermined empty weight), foodstuff temperature sensor reading (e.g., cavity is occupied if the foodstuff temperature sensor is connected), appliance temperature sensor reading (e.g., cavity is occupied if the reading decreases below a threshold, such as after having reached a preheat threshold), cook cavity temperature, appliance door open and/or door close, and/or any other sensor reading. The cavity state belief vote can be determined using a classifier (e.g., trained to determine the cavity state based on the auxiliary sensor readings), a lookup table, a set of heuristics (e.g., wherein the auxiliary sensor reading values or series thereof are associated with a cavity state), and/or otherwise determined.

In a third variant, the cavity state belief vote is determined based on auxiliary sensor readings optionally combined with previous belief states, such as a door open and close event combined with the most recent previous belief state (e.g., cavity is occupied if a door open and close event is detected and the previous belief is empty; and the cavity is not occupied if a door open and close event is detected and the previous belief is full). An example is depicted in FIG. 3.

However, determining one or more cavity state belief votes can additionally or alternatively include any other suitable elements.

Determining a final cavity belief state S400 can function to combine the cavity state belief votes and optionally a prior cavity state to determine a final cavity belief state (final cavity state). The final cavity belief state (belief cavity state) can be binary (e.g., empty or full), can be a value between a range wherein the bounds of the range indicate either empty or full cavity state, and/or be any other suitable indicator. The final cavity belief state can optionally be stored in a datastore (e.g., state history datastore, such as local to and/or remote from the device) and/or any other suitable memory local to or not local to the device. The final cavity belief state stored in association with a time of state determination, and/or any other information. The final cavity belief state, however, need not be stored.

In a first variant, the final cavity belief state can be determined by taking the majority vote of the cavity state belief votes determined in S300.

In a second variant, the final cavity belief state can be determined by aggregating one or more confidence scores of the cavity state belief votes. Optionally the confidence scores can be weighted based on heuristics (e.g., if cavity measurement is known to be more or less reliable than other cavity measurements).

In a third variant, the final cavity belief state can be determined using heuristics, such as when the confidence score is below a threshold, default to the “safest” option (e.g., low power pre-heat, turning off the oven, asking the user, etc.).

In a fourth variant, the final cavity belief state can be determined by bypassing the cavity state belief votes and querying the user for the user's belief of the cavity state and using the user's response (e.g., including full or empty) as the final cavity belief state.

In a fifth variant, the final cavity belief state can be determined using the prior cavity belief state. In a first example, when the prior cavity belief state is empty and a door open and/or close event is not detected, then the final cavity belief state can be empty. In a second example, when the prior cavity belief state is full and a door open and/or close event is not detected, then the final cavity belief state can be full.

In a sixth variant, the final cavity belief state can be the cavity state output by the classification module (e.g., the classifier).

However, determining the final cavity belief state can additionally or alternatively include any other suitable elements.

Determining whether the final cavity belief state and the expected cavity state match S500 functions to compare the final cavity belief state to the expected cavity state to determine whether the cook instruction can be performed. However, S500 can optionally not be performed. In variants when the final cavity belief state and the expected cavity state are binary, the match can be determined using a logic gate, more specifically a digital comparator, such as a magnitude comparator, but can additionally or alternatively use an AND gate, the opposite output of an XOR gate, and/or any other suitable logic gate. The match can additionally or alternatively be determined using heuristics and/or any other suitable technique. In variants, when the final cavity belief state and the expected cavity state are not binary, the match can be determined using thresholding (e.g., if both values are greater than and/or less than a predetermined value). An example is depicted in FIG. 4. However, the match can additionally or alternatively be otherwise determined.

The method preferably includes operating based on the match S600, which can function to execute downstream functionalities based on whether the actual state matches the expected state. S600 can be automatically, manually, or otherwise performed.

Examples of downstream functionalities that can be executed include: operating the appliance based on the cook instruction or a default instruction, facilitating cavity transition to the expected state, sending notifications to a user, and/or other downstream functionalities. Examples are depicted in FIGS. 3 and 4.

Operating based on the match can include operating the appliance. Operating the appliance can include operating the appliance according to the cook instructions or otherwise operating the appliance. Examples include: operating the one or more heating elements in a pre-heat mode (e.g., high-power mode, such as greater than 1800 watts, less than or equal to 1800 watts, etc.; low-power mode, such as less than the wattage of the high power mode, such as less than 1800 watts, less than 1500 watts, less than 1200 watts, etc.), operating the heating elements according to the operation instructions (e.g., secondary operation instructions associated with identified foodstuff), shutting off the heating elements, and/or otherwise operating the appliance.

In a first variant, S600 can include operating the appliance according to a pre-heat instruction in a high-power mode when the cook instructions are to preheat and the final cavity belief state is empty.

In a second variant, S600 can include operating the appliance in a low-power mode (e.g., food class-specific cook instructions; next set of cook instructions; etc.) when the cook instructions are to preheat and the final cavity belief state is not empty (e.g., the empty class is not the highest-probability class). In a specific example, when the cook cavity temperature is less than a predetermined temperature (e.g., specified by the food class-specific cook instructions), the cooking instructions can be dynamically adjusted (e.g., increased, based on the difference between the starting cook cavity temperature and target cavity temperature, etc.) or otherwise managed.

Operating based on the match can include sending a notification to a user, which can function to notify the user, ask the user to perform an action, and/or elicit information from the user. Sending a notification to a user can include determining a user action (e.g., turn off the appliance, turn on the appliance, insert foodstuff into the cavity, remove foodstuff from the cavity, etc.) for which to communicate to the user. The user action can be determined based on the match, the cook instruction, the expected cavity state, cavity state belief votes, and/or the final cavity belief state. The notification can be received on: on the appliance, on a user device, and/or otherwise received by the user. The notification can be a push notification, text message, email, phone call, and/or any other notification. The notification can include the user action, one or more cavity measurements and/or processed cavity measurements (e.g., determined event, class label, etc.), one or more cavity belief state votes, final cavity belief state, the match, and/or any other suitable information. The notification can be sent directly to a user and/or indirectly to a user (e.g., to a server, which can forward the notification and/or send a generated notification to the user). The notification can be sent during a cook session (e.g., during execution of a cook program), after a cook session (e.g., the notification can be a reminder to remove foodstuff from the cavity), before a particular cook instruction (e.g., the notification can be to insert foodstuff into the cavity), after a particular cook instruction (e.g., the notification can be to remove foodstuff from the cavity), and/or the notification can be sent at any other suitable time. The notification can additionally or alternatively be stored in the datastore for later use.

The following are examples of S600 when the cavity state is determined to be empty. In a first example, if the heating elements are on (e.g., for more than a predetermined duration), S600 can include notifying the user to turn off the appliance. In a second example, when the cook instruction is to pre-heat, S600 can include pre-heating the appliance. In a third example, when the selected cook program does not include a pre-heat step, S600 can include notifying the user to insert foodstuff into the cavity (e.g., after the cavity is empty for a predetermined period of time after cook instruction receipt, such as when the user forgets to insert foodstuff, when the prior cavity state was empty; etc.).

The following are examples of S600 when the cavity state is determined to be full. In a first example, when the cook instruction is pre-heat, S600 can include not pre-heating the appliance, using low power to heat the cavity (e.g., at the cooking temperature for the identified foodstuff), turning off preheat, and/or notifying the user. In a second example, when the cook program is complete, S600 can include notifying the user to remove foodstuff from the cavity. In a third example, when the appliance is already pre-heating in a high-power mode, S600 can include terminating pre-heat (e.g., switch to low power pre-heat, turn off oven, etc.). For example, if it is determined that a user forgot to remove foodstuff from a previous usage (e.g., by determining that a previous cavity state is full, then determining cook program completion, and then not detecting a door open and close event), then S600 can include terminating pre-heat and/or notifying the user to remove foodstuff from the cavity.

However, operating based on the match can additionally or alternatively include any other suitable elements.

In an illustrative example, the method includes: receiving cook instructions; detecting a trigger event (e.g., a door open event, door close event, state change event, etc.); taking a series of measurements of the cook cavity (e.g., series of images); and classifying the measurement(s) (e.g., images) as at least one of a plurality of classes with a classifier (e.g., multiclass classifier). The plurality of classes can include an empty cavity state and one or more food classes, and can optionally include one or more sensor state class(es) (e.g., clean or dirty camera, connected or disconnected probe). When the cook instructions include a preheat instruction, the method can include operating the appliance according to the preheat instructions when the measurement(s) (e.g., more than a threshold number of measurements from the series) are classified with an empty cavity state (e.g., the empty cavity state has the highest probability out of all possible classes output by the classifier); and skipping the preheat instructions when the measurement(s) are classified with a class other than the empty cavity state. The method can optionally include operating the appliance based on other instructions within the cook instruction set (e.g., associated with the detected food class; user-specified instructions; etc.). When the cook instructions do not include a preheat instruction, the method can optionally include querying the prior cavity state (e.g., immediately prior cavity state) when the measurement(s) are classified with an empty cavity state and inferring user intent based on the prior cavity state (e.g., using a ruleset or set of heuristics). For example, when the prior cavity state is empty, the system can infer that the user meant to put food into the cavity, and notify the user to insert food. In a second example, when the prior cavity state is not empty (e.g., occupied), the system can infer that the user meant to turn off the heating elements, and turn off the heating elements (if the heating elements are still operating). The method can be iteratively performed (e.g., when each trigger event is detected), performed before appliance operation, performed during a cook session, or performed at any other suitable time. However, the method can be otherwise performed.

Different processes and/or elements discussed above can be performed and controlled by the same or different entities. In the latter variants, different subsystems can communicate via: APIs (e.g., using API requests and responses, API keys, etc.), requests, and/or other communication channels.

An alternative embodiment implements the above methods and/or processing modules in a computer-readable medium storing computer-readable instructions. The instructions are preferably executed by computer-executable components integrated with the system. The computer-readable medium may be stored on any suitable computer readable media such as RAMs, ROMs, flash memory, EEPROMs, optical devices (CD or DVD), hard drives, floppy drives, non-transitory computer readable media, or any suitable device. The computer-executable component is preferably a processor but the instructions may alternatively or additionally be executed by any suitable dedicated hardware device. The computing systems disclosed above can include one or more physical processors (e.g., CPU, GPU, microprocessors, ASICs, etc.) and/or other computer-executable component or hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method for cooking cavity control, comprising:
receiving a pre-heat instruction associated with an expected cavity state;
capturing a sensor measurement for a the cooking cavity of an appliance;
determining a belief cavity state using the sensor measurement;
determining whether the belief cavity state matches the expected cavity state;
when the belief cavity state matches the expected cavity state, operating the appliance according to the pre-heat instruction; and
when the belief cavity state does not match the expected cavity state, not operating the appliance according to the pre-heat instruction.

2. The method of claim 1:
wherein operating the appliance according to the pre-heat instruction, comprises operating the appliance in a high-power mode;
wherein the method further comprises operating the appliance in a second mode with a lower power output than the high-power mode when the belief cavity state does not match the expected cavity state.

3. The method of claim 2, wherein a minimum power output in the high-power mode is 1800 watts.

4. The method of claim 1, wherein the belief cavity state matches the expected cavity state when a confidence score for an empty class label determined for the belief cavity state is higher than other confidence scores for food class labels.

5. The method of claim 1, further comprising:
while operating the appliance according to the pre-heat instruction, detecting a foodstuff insertion event; and
in response to the foodstuff insertion event, automatically operating the appliance in a second mode with a lower power output than a power output associated with the preheat instruction.

6. The method of claim 1, wherein the sensor measurement is captured using an image sensor.

7. The method of claim 1, wherein the pre-heat instruction is received from a remote device.

8. The method of claim 1, wherein the sensor measurement is part of a sensor measurement set, wherein each sensor measurement of the sensor measurement set is captured by a different sensor, and wherein each sensor measurement of the sensor measurement set is associated with a different belief state vote, and wherein the belief cavity state is determined by a majority vote of the belief state votes.

9. The method of claim 1, wherein the belief cavity state is determined using a trained neural network.

10. The method of claim 9, wherein the trained neural network is trained to determine a plurality of classes, wherein the plurality of classes comprises food classes and a cavity state class.

11. The method of claim 10, wherein the plurality of classes further comprises camera state classes.

12. The method of claim 9, wherein the trained neural network is trained on images depicting an empty cavity, wherein the images are captured by a dirty camera.

13. The method of claim 1, wherein the method is performed onboard the appliance.

14. A system for cavity state determination, comprising:
an appliance, comprising a sensor set and a cook cavity;
a processor, configured to:
a) receive a pre-heat instruction and secondary operation instructions, wherein the pre-heat instruction is associated with an empty cavity state;
b) determine a cavity state of the cook cavity using a sensor measurement of the cook cavity, captured by the sensor set;
c) operate the appliance according to the pre-heat instruction when the cavity state matches the empty cavity state; and
d) operate the appliance according to the secondary operation instructions when the cavity state does not match the empty cavity state.

15. The system of claim 14, further comprising selectively sending a user notification based on a prior cavity state in combination with the sensor measurement.

16. The system of claim 14, wherein the appliance comprises variable control heating elements that are operable in at least an off mode, a medium mode, and a maximum mode, wherein the maximum mode operates the heating elements at a minimum power output of 1800 watts.

17. The system of claim 14, wherein determining the cavity state comprises classifying the sensor measurement as one of a set of predetermined classes using a trained neural network, wherein the set of predetermined classes comprises an empty cavity state.

18. The system of claim 17, wherein the set of predetermined classes further comprises food classes.

19. The system of claim 18, wherein the secondary operation instructions are specific to a food class, wherein the processor operates the appliance according to the secondary operation instructions when the sensor measurement is classified with a food class associated with the secondary operation instructions.

20. The system of claim 14, wherein the processor is further configured to:
detect a state change event; and
repeat b)-d) when the state change event is detected.
